(19) United States
(12) Patent Application Publication
(10) Pub. No.: US 2012/0260813 A1
(43) Pub. Date: Oct. 18, 2012

(54) METHOD AND DEVICE FOR MEASURING A RUNNING DIRECTION OF A SUBSTRATE WEB

(76) Inventors: Ingo Neuber, Bornstein (DE); Holger Runkowske, Probsteierhagen (DE); Stefan Schluenss, Schacht-Audorf (DE); Andreas Mandik, Kiel (DE)

(21) Appl. No.: 13/496,541

(22) PCT Filed: Sep. 16, 2010
(86) PCT No.: PCT/EP2010/063591

§ 371 Date: Jun. 27, 2012

(30) Foreign Application Priority Data
Sep. 30, 2009 (DE) 10 2009 047 776.4

(51) Int. Cl. B41L 21/00; G01L 1/24; B65H 23/02; G01L 1/00

(52) U.S. Cl. 101/481; 73/862.637; 73/862.624; 73/862.541; 226/3; 226/19

(57) ABSTRACT

Disclosed are a method and a device for measuring a running direction of a substrate web (6). The method for measuring a running direction of a substrate web consists of the substrate web (6) being guided around a measuring roller (12), at least one bearing force of the measuring roller (12) being measured, and the running direction of the substrate web (6) being determined based on the measured bearing force. The device (10) for measuring the miming direction of a substrate web (6) comprises a measuring roller (12), with the substrate web (6) being guided around said measuring roller (12). Furthermore, the device (10) comprises at least one sensor (18a, 18b, 18c) for measuring a bearing force of the measuring roller (12) and comprises an evaluation circuit, said evaluation circuit being connected to the at least one sensor (18a, 18b, 18c) and being suitable for determining an alignment of the substrate web (6) based on the bearing force measured by the sensor (18a, 18b, 18c).

### FIELD OF THE INVENTION

The present invention relates to a device for measuring an alignment of a substrate web in a processing machine in a direction transverse to the transport direction of said substrate web.

### BACKGROUND OF THE INVENTION

In the art, substrate webs are subjected to numerous processes such as, for example, cutting, welding, chemical treatments and printing. Hereinafter, printing of a substrate web is described as an example of such a process. However, it should be noted that the devices and methods in accordance with the invention can also be applied to other fields, for example, to the processing of foils and textiles.

When printing a substrate web, for example, said web is reeled off a first roll, moved past one or more printing units of a printing machine, and is then taken up by a second roll or cut into suitable sheets. Inside the printing units, a coating material such as, for example, printing ink, ink or toner is used for applying a printed image to the substrate web.

Inside the printing machine, the substrate web is deflected several times over a plurality of guide rollers and/or transport rollers, so that long path segments are formed within the printing machine. It is desirable that the substrate web be guided in a controlled straight manner through the printing machine.

During a printing operation, it is particularly important that the substrate web move in a straight manner, i.e., without deviations from its alignment. A deviation to the right or left toward the sides of the transport rollers causes a shift of a printing image to be applied to the substrate web and may result in a poor printed image. When a printing machine comprises several successively arranged printing units for different colors, even minimal deviations from the alignment of the substrate web lead to registration errors between the printing units. Furthermore, greater deviations of the substrate web from its straight running direction can cause warping and creasing of the substrate web and the substrate web may even tear.

A controlled straight movement is intended to prevent registration errors, on the one hand, and to limit the forces acting on the substrate web to essentially one direction, namely along the transport path, on the other hand.

In known printing machines, the position and the alignment of a substrate web is detected, for example, by means of an edge sensor that senses the position of a lateral edge of the substrate web. Such an edge sensor may comprise, for example, light barriers, laser sensors or cameras that track the course of the lateral edge of the substrate web. An electronic control system compares chronologically successive position measurements of the edge sensors, uses them to determine a positional deviation, in particular a skewed movement of the substrate web, and correspondingly actuates an adjustment unit in order to adjust the running direction of the substrate web.

With this known device and this known measuring method, however, there exists the problem that the substrate web displays deviations in width and irregularities along the cutting edges. Such deviations occur, for example, due to irregular cutting edges of, or minimal damage to, the substrate web. They do not pose any problems as far as the final product is concerned because the substrate web is usually first treated or printed, and cut to size after the treatment or printing process. However, such irregularities of the lateral edges may affect the straight movement when the straight movement is being controlled.

### DESCRIPTION OF THE INVENTION

The transport and printing speed of a printing machine is rather high in most cases, and known position-control systems respond very quickly to only minor deviations from the desired position because already minimal positional deviations of the substrate web may have a disadvantageous effect on the printed image, and may bring about the formation of creases or tears of the substrate web.

It is therefore the object of the present invention to provide a device and a method for measuring an alignment of a substrate web in a printing machine in a direction transverse to a transport direction of the substrate web, said device and method preventing the above-described disadvantages.

This object is achieved with a method as in claim 1, claim 9 and claim 13, as well as with a device as in claim 15 and claim 19. Additional embodiments of the invention result from the subclaims.

In particular, a method for measuring a running direction of a substrate web is provided, said method consisting in that the substrate web is guided around a measuring roller, wherein at least one bearing force of the measuring roller is being measured and the running direction of the substrate web is determined based on the measured bearing force. As a result of this, a rapid measurement of the position and running direction of the substrate is made possible, independent of the lateral edge contours of said substrate web.

Advantageously, measuring of the bearing force comprises measuring of an axial bearing force of the measuring roller. The reason being that a change of the axial bearing force occurs whenever the substrate web does not move in a straight running direction around the measuring roller and thus provides rapid feedback about those changes.

Alternatively or additionally to measuring an axial bearing force, the method comprises measuring of radial bearing forces at two axially spaced apart points of the measuring roller. As a result of this, the radial bearing forces can be compared to each other and, based on this comparison, conclusions can be drawn regarding the position and the running direction of the substrate web. Preferably, in so doing, the measuring of the radial forces comprises measuring of the radial bearing forces at opposite ends of the measuring roller. Thus, the greatest possible spacing of the measured radial forces and thus a good resolution of the final determination of the position and of the running direction of the substrate web are achieved. In one embodiment, the determination of the running direction of the substrate web comprises the determination of a difference between the radial bearing forces.

In another embodiment, the method comprises the step of measuring a position of the edge of the substrate web. As a result of this, another measured value is provided for monitoring, or, in case of a malfunction, a value of a force measurement for determining the position and the running direction of the substrate web. The position of the edge of the substrate web is preferably measured by optical means and, thus, in a contactless manner. In addition, a measuring signal relating to the position of the edge is preferably filtered through a low-pass filter in order to filter out measuring noise and any minor unevenness.

Also disclosed is a method in accordance with the invention for the alignment of the running direction of a substrate web, wherein the running direction is determined by an embodiment of the above-explained method, and the running direction is adjusted by means of at least one adjustment element. As a result of this, a quick correction of the position and of the running direction of the substrate web becomes possible.

This method for aligning the running direction of a substrate web provides that the running direction be preferably adjusted by means of at least one controllable adjustment roller, this being particularly treats with care the substrate web as well as the adjustment element.

In accordance with one exemplary embodiment of the method for aligning the running direction of a substrate web, the running direction is determined—in transport direction—upstream of the adjustment element. As a result of this, an error regarding the position and the running direction of the substrate web can be determined prior to a correction by the adjustment element.

In accordance with one exemplary embodiment of the method for aligning the running direction of a substrate web, the running direction is determined—in transport direction—upstream and downstream of the adjustment element, so that an error regarding the position and the running direction of the substrate web can be determined prior to a correction by the adjustment element and that, thereafter, the success of the correction can be determined.

Furthermore, an inventive method for preparing a graph for the determination of the position of a substrate web relative to a measuring roller is disclosed, wherein the substrate web is guided around the measuring roller. First radial bearing forces at two points, axially spaced apart of the measuring roller are measured, in which case the substrate web is arranged in a first defined position on the measuring roller, and a first difference between the two radial bearing forces is determined. Subsequently, second radial bearing forces are measured at two points, axially spaced apart, of the measuring roller, the substrate web being arranged in a second defined position of the measuring roller. Then, a second difference between the two radial bearing forces is determined, and a relationship between a position of the substrate web on the measuring roller and a difference of radial bearing forces is determined based on the first and second differences and the corresponding first and second defined positions. Consequently, the absolute position and also a change of the position and the running direction of the substrate web can be determined.

A device in accordance with the present invention, said device being used for measuring the running direction of a substrate web with a measuring roller around which the substrate is being guided, comprises at least one sensor for measuring a bearing force of the measuring roller and comprises an evaluation circuit, said evaluation circuit being connected to the at least one sensor and being suitable for determining an alignment of the substrate web based on the bearing force measured by the sensor. As a result of this, it is possible to determine a change of the position and of the running direction of the substrate web, independent of the lateral contours of said substrate web.

The at least one sensor is preferably suitable for measuring an axial bearing force, because the axial bearing force is able to indicate changes of the running direction of the substrate web.

In one exemplary embodiment, two sensors of the device are suitable for measuring a radial bearing force. As a result of this, a comparison of the radial bearing forces becomes possible, said comparison allowing conclusions regarding the position and the running direction of the substrate web.

The sensors for measuring the radial bearing force are preferably aligned in such a manner that they perform measurements in the direction of the bisector of the wrap angle of the substrate web around the measuring roller. As a result of this, the total value of the radial bearing force is measured and not only one component of the bearing force.

Furthermore, in accordance with the present invention, a device for adjusting the running direction of a substrate web in a direction transverse to the transport direction of said substrate web is provided, said device comprising a device for measuring the running direction in accordance with one of the above-explained embodiments and comprising at least one adjustment element for adjusting the running direction of the substrate web. As a result of this, a quick correction of the position and of the running direction of the substrate web becomes possible.

In the device for adjusting the running direction of a substrate web, the device for measuring the running direction is advantageously arranged upstream of the adjustment element. This means that an error regarding the position and the running direction of the substrate web can be detected prior to a correction by the adjustment element.

In a further exemplary embodiment of the device for adjusting the running direction of a substrate web, a second device for measuring the running direction of a substrate web is provided, and, respectively, one device for measuring the running direction of a substrate web is arranged—in transport direction of the substrate web—upstream and downstream of the at least one adjustment element. Thus, it is possible to first detect an error regarding the position and the running direction of the substrate web prior to a correction by the adjustment element, and, thereafter, the success of the correction can be determined. However, it is also possible to provide only one measuring device downstream of the at least one adjustment element.

The adjustment element of the device for adjusting the running direction of a substrate web preferably comprises at least one controllably movable adjustment roller. This is particularly treats with care the substrate web as well as the adjustment element.

In accordance with another exemplary embodiment, the device for adjusting the running direction of a substrate web comprises an edge sensor for measuring the position of the edge of the substrate web. As a result of this, another measuring value can be provided for the determination of the position and of the running direction of the substrate web.

A printing machine in accordance with the invention comprises at least one printing unit and one device for measuring the running direction of a substrate web in order to ensure a contactless and accurate measurement of the position and of the alignment of the substrate web.

Referring to this printing machine, the device for measuring the running direction is arranged—in transport direction of the substrate web—upstream of the at least one printing unit. As a result of this, an error regarding the position and the running direction of the substrate web can be determined upstream of the printing unit.

In accordance with a further embodiment of the printing machine, the device for measuring the running direction of a substrate web is provided on an adjustment element for adjusting the running direction of the substrate web. Thus, the adjustment element is preferably part of a roller frame of the printing machine. This enables savings because no measuring roller used for measuring need be provided.

Hereinafter, the invention will be explained in greater detail with reference to various embodiments and with reference to the drawings. They show in.

### BRIEF DESCRIPTION OF THE DRAWINGS

FIG. 1: a schematic side view of a printing machine comprising a measuring device for measuring an alignment of a substrate web;

FIG. 2a: a schematic front view of a device for measuring the running direction of a substrate web, wherein the forces acting on a substrate web moving in a straight manner are illustrated;

FIG. 2b: a schematic front view of a device for measuring the running direction of a substrate web, wherein the forces acting on a substrate web moving in a skewed manner are illustrated;

FIG. 3: a side view of a device for adjusting the running direction of a substrate web;

FIG. 4: a graph of an axial bearing force and of the difference of the radial bearing forces of the device for measuring the running direction of a substrate web, as shown in FIGS. 2a and 2b, in relation to an offset of the substrate web in axial direction.

### DETAILED DESCRIPTION OF THE INVENTION

It should be noted that the expressions above, below, right and left and similar indications used in the description hereinafter relate to the alignments and/or arrangements in the figures and are only meant to describe the exemplary embodiments. However, these expressions must not be understood to be restrictive.

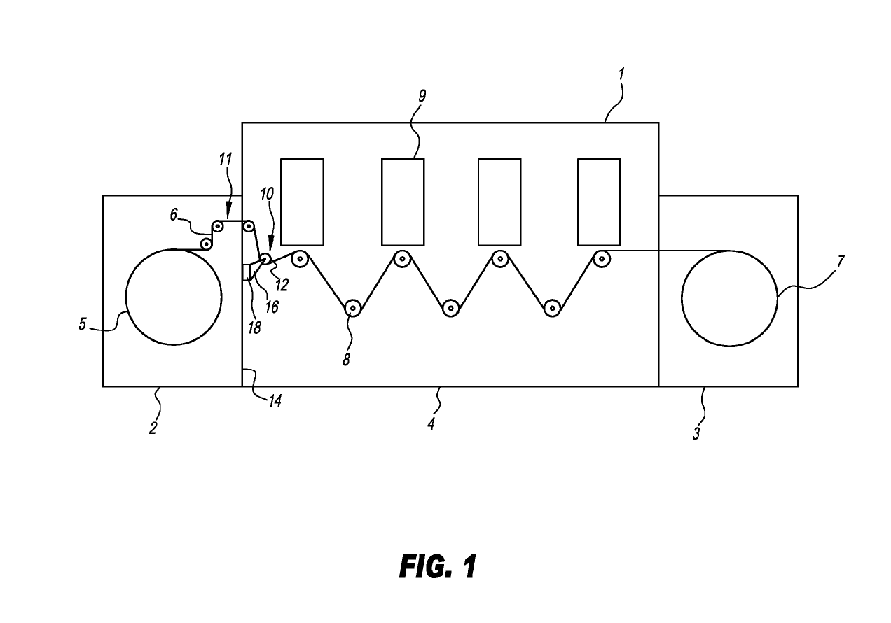

FIG. 1 shows a schematic side view of a printing machine 1. The lateral cover was left off in FIG. 1 in order to clear the view into the inside of the printing machine 1. The printing machine 1 comprises a feeder 2, an output region 3, as well as a printing region 4 located in between. A substrate web roll 5 is rotatably supported in the feeder 2, a substrate web 6 being guided from said roll through the printing region 4 to a substrate web take-up roll 7 in the output region 3. During a printing operation, the substrate web 6 is conveyed from the substrate web roll 5 to the substrate web take-up roll 7 via a plurality of transport rollers 8 in the printing region, only a few of said transport rollers being shown in order to simplify the illustration.

The printing region 4 comprises a plurality of printing units 9 as well as the plurality of transport rollers 8. Only seven of the transport rollers 8 are schematically shown in FIG. 1; however, as a rule, a larger number is provided, said transport rollers conveying the substrate web 6 along a non-linear transport path through the printing region 4. FIG. 1 shows four printing units 9, so that the printing machine 1 in accordance with FIG. 1 would be suitable for four-color printing. However, depending on use, it is also possible to provide a number of printing units 9 different therefrom.

A measuring device 10 for measuring a running direction of the substrate web 6 in the printing machine in a direction transverse to the transport direction of said web is provided between the feeder 2 and the first printing unit 9. Furthermore, an adjustment device 11 for adjusting a position of the substrate web 6 transversely to the transport direction of said web is arranged between the substrate web roll 5 and the measuring device 10, said adjustment device being described later in detail. Alternatively, it is also possible to arrange the measuring device 10 upstream of the adjustment device 11 or even to arrange two measuring devices 10 on both sides relative to the adjustment device 11.

In this description, the expression “position” of the substrate web 6 is understood to mean the position of the substrate web 6 transverse to the transport direction of said web, whereas the expression “running direction” is understood to mean an angular alignment of the substrate web 6 relative to the ideal transport direction or a center line of the printing machine 1. For example, a substrate web 6 may be in a centered position on one of the transport rollers 6 and still be skewed in running direction, because said web moves in and out in a skewed manner relative to the transport roller 8. In exactly the same way, the substrate web 6 may display a straight running direction and still not be in a centered position relative to a transport roller 8.

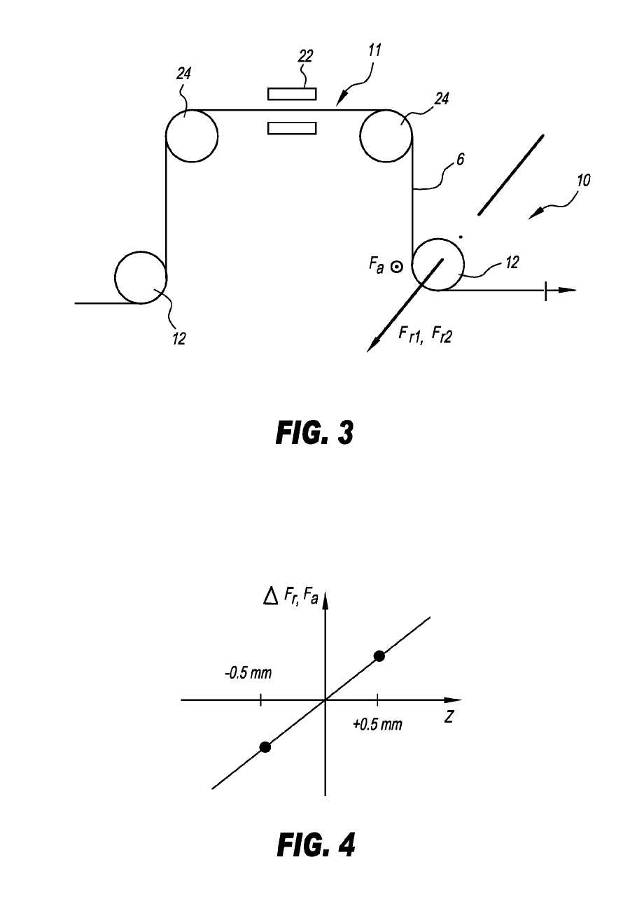

The device 10 for measuring the running direction of the substrate web 6 comprises a measuring roller 12, said transport roller being supported on a schematically illustrated frame 14 of the printing machine 1 by means of a measuring roller frame 16. At least one sensor 18 for measuring a bearing force of the measuring roller 12 is provided. The sensor 18 is connected to an evaluation circuit not shown. The substrate web 6 is guided around the measuring roller 12, as is best seen in FIGS. 1 and 3, and is tensioned in its transport direction.

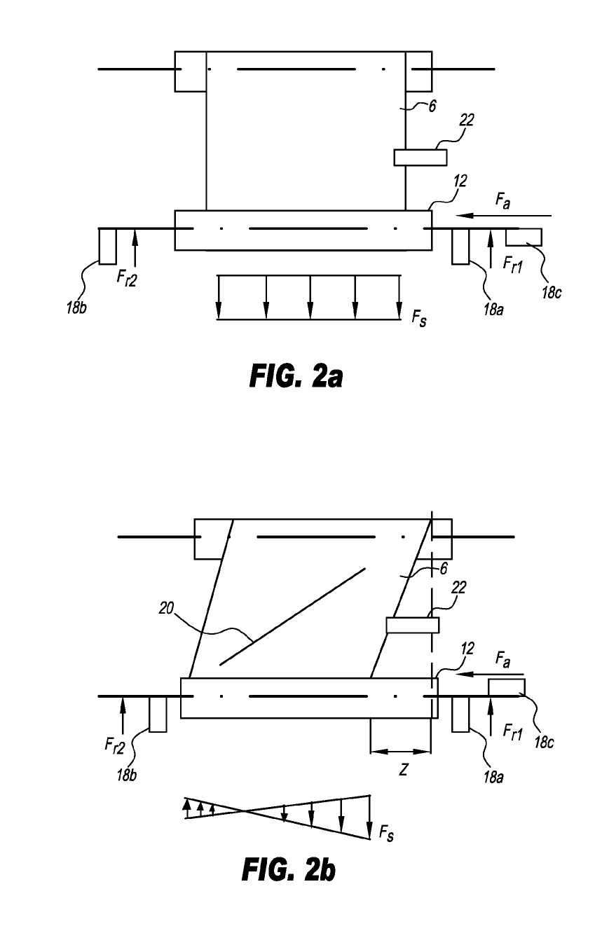

The measuring roller 12 is statically supported on both its axial ends, i.e., one bearing is suitable for absorbing a radial and an axial bearing force, whereas the other bearing is only suitable for absorbing a radial bearing force. Referring to FIG. 2, the relationships between the radial and axial bearing forces with a straight and with a skewed running direction of a substrate web will now be explained.

First, the case shown in FIG. 2a will be described; here, the substrate web 6 is guided in a centered manner and in a straight running direction around measuring roller 12. In this case, a uniform tensioning force F_{S} is applied to the substrate web 6 across the entire width of said web. A right radial bearing force Fᵣ₁ and a left radial bearing force Fᵣ₂ are acting on opposite ends of the measuring roller 12 in the opposite direction of the tensioning force F_{S}. It is also possible for the right or the left bearing of the measuring roller 12 to absorb an axial bearing force Fₐ. In FIGS. 2a and 2b, it is the right bearing that absorbs the axial bearing force Fₐ.

In the case shown in FIG. 2a the right radial bearing force Fᵣ₁ is equal to the left radial bearing force Fᵣ₂, because the substrate web 6 is aligned centered relative to the measuring roller 12. FIG. 2a shows an arrangement, wherein the axial bearing force Fₐ can be absorbed by the right bearing of the measuring roller 12. Although an axial bearing force Fₐ is drawn in FIG. 2a, the value of said force is zero because no axial bearing force Fₐ occurs with an evenly distributed tensioning force F_{S}.

FIG. 2b shows a situation, wherein the substrate web 6 is guided around the measuring roller 12 in a manner skewed relative to the running direction. In comparison with the situation of a straight running direction shown by FIG. 2a, an offset z in axial direction occurs here. This offset z causes the tensioning force F_{S} of the substrate web 6 to no longer be evenly distributed across the width of said substrate web, as is schematically shown in FIG. 2b. Depending on the size of the offset z, it is even possible for a crease 20 to form in the substrate web 6. Also in this situation, a right radial bearing force Fᵣ₁ and a left radial bearing force Fᵣ₂ will occur, the sum of said bearing forces being equal to the tensioning force F_{S} of the substrate web 6 but acting in opposite directions. Inasmuch as the substrate web 6, however, is not centered on the measuring roller 12 and also has a running direction that is skewed relative thereto, the radial bearing forces Fᵣ₁ and Fᵣ₂ are not equal in size. In addition, the axial bearing force Fₐ does not equal zero.

FIG. 3 shows the adjustment device 11 and the measuring device 10 from the side, this also corresponding to a side view of FIGS. 2a and 2b. In FIG. 3, the substrate web 6 is guided at an angle of approximately 90° around the measuring roller 12 and is tensioned with the tensioning force F_{S}. The resultant radial bearing forces Fᵣ₁ and Fᵣ₂ act in the direction of the angle bisector between the incoming portion and the outgoing portion of the substrate web 6. The axial bearing force Fₐ is directed perpendicular to the plane of the sheet.

One or more sensors 18 are arranged between the measuring roller 12 and the frame 14 of the printing machine, said sensors being suitable to measure the radial bearing forces Fᵣ₁, Fᵣ₂ and the axial bearing force Fₐ. For example, a first force sensor 18a measures the right radial bearing force Fᵣ₁, a second force sensor 18b measures the second radial bearing force Fᵣ₂, and a third force sensor 18c measures the radial bearing force Fₐ. The force sensors 18a, b, c are connected with an evaluation circuit not shown, said circuit being suitable to determine—based on the sensor output values—the alignment and position of the substrate web relative to the measuring roller 12.

The adjustment device 11 shown in FIG. 3 comprises two rollers 24 that can be adjusted by means of an adjustment unit. By changing the position of the rollers 24, it is possible to influence the running direction and the position of the substrate web 6. Such an adjustment device 11 has been known in the art and will therefore not be specifically explained here.

The position of the adjustment rollers 24 is influenced by a not illustrated electronic control system that receives data from at least one measuring device 10. As is indicated in FIG. 3—viewed in running direction of the substrate web 6—one measuring device 10 is arranged upstream of the adjustment device 11 and one measuring device is arranged downstream of the adjustment device 11, with only the rollers 12 being shown in each case.

First, the substrate web 6 is guided at an angle of approximately 90° around the roller 12 of the first measuring device 10, then at an angle of approximately 90° around the rollers 24 of the adjustment device 11, and, finally, again at angle of 90°, around the roller 12 of the second measuring device 10. The substrate web 6 need not wrap around the respective rollers at an angle of 90°. However, preferably, it should wrap around within a range of 30° and 100°, in particular between 60° and 90°.

With the use of the arrangement as shown in FIG. 3, said arrangement comprising two measuring devices 10, it is possible to determine the running direction of the substrate web 6 upstream as well as downstream of the adjustment device 11 in order to be able to provide better control. In order to detect the position of the lateral edge of the substrate web 6, an additional known edge sensor 22 may be provided. The edge sensor data may then also be used for the control of the adjustment device 11.

Inasmuch as, as a rule, the position of the lateral edge changes only very slowly when the substrate web 6 moves in a straight direction, a signal of the edge sensor may be filtered through a low-pass filter in order to prevent any unevenness of the lateral edge from entering the control.

It should be mentioned that the adjustment device 11 and the device 10 for measuring the running direction of a substrate web 6 are arranged in the printing machine 1 upstream of the printing units 9. As a result of this arrangement of the device 10, it is possible to determine a running direction and a position of a substrate web 6 before said substrate web moves into the printing units 9. Consequently, errors regarding the position and the running direction of the substrate web 6 can be corrected prior to the occurrence of a misprint in the printing unit 9. However, it is also possible to provide the adjustment device 11 and the measuring device 10 downstream of, or also between, the printing units 9 of the printing machine 1. In the arrangement shown in FIGS. 1-3, the measuring roller 12 and the adjustment rollers 24 are part of a roller frame of the printing machine 1.

Hereinafter, various embodiments of operation of the measuring device 10 are described. Depending on how many force sensors 18 the measuring device 10 comprises, various methods are taken into consideration.

First, a look shall be taken at the simplest case of a first exemplary embodiment, said embodiment comprising only one force sensor 18c that measures an axial bearing force Fₐ of the measuring roller 12. With this method, the axial force Fₐ is measured continuously while the substrate web 6 is guided around the measuring roller 12 and tensioned with the tensioning force F_{S}. The force sensor 18c transmits the value of the axial bearing force Fₐ measured by said force sensor to a not illustrated electronic evaluating system, where changes of the axial bearing force Fₐ are recorded. As long as the axial force Fₐ is equal to zero or very close to zero, a determination is being made that the substrate web 6 is being guided in a straight running direction around the measuring roller 12. The greater the axial bearing force Fₐ measured by the force sensor 18c, the greater the deviation of the running direction of the substrate web 6 from the ideal, straight running direction. The direction of deviation is in relation to the direction or the algebraic sign of the axial bearing force Fₐ measured by the force sensor 18c. For example, an axial bearing force Fₐ with a positive sign represents a deviation of the running direction to the left, and a bearing force Fₐ with a negative sign represents a deviation of the running direction to the right.

In accordance with another exemplary embodiment, a radial bearing force Fᵣ₁ or Fᵣ₂ and the axial bearing force Fₐ are measured by the force sensors 18a or 18b, as well as 18c. As mentioned above, the value of the axial bearing force Fₐ represents the degree of deviation of the running direction of the substrate web 6 from the ideal, straight running direction. The value of the radial bearing force Fᵣ₁ or Fᵣ₂ is a function of the position of the substrate web 6 relative to the measuring roller 12. Depending on the running direction and the position of the substrate web 6, the measured radial force Fᵣ₁ or Fᵣ₂ will take on different values. These values, for example, depend on how far the right edge of the substrate web 6 is from the right edge of the measuring roller 12. If the value of the radial bearing force Fᵣ₁ or Fᵣ₂ at two known positions of the substrate web 6 is known, an absolute position of the substrate web 6 relative to the measuring roller 12 can be determined by interpolation. For example, the radial bearing force Fᵣ₁, Fᵣ₂ is measured in a situation in which the right edge of the substrate web 6 is superimposed with the right edge of the measuring roller 12, and a second radial bearing force is determined when the right edge of the substrate web 6 is at a distance by a defined offset z, for example 0.5 mm, from the edge of the measuring roller 12. These two known relationships of offset z and the bearing force can be entered in a characteristic field or a graph as is shown, for example in FIG. 4. By interpolation between points of a known relationship between the bearing force and the position of the substrate web 6, it is possible to determine an offset z—based on a measured radial bearing force Fᵣ₁, Fᵣ₂—by interpolation.

In accordance with yet another exemplary embodiment, the radial bearing forces Fᵣ₁ and Fᵣ₂ are measured at two spaced apart points of the measuring roller 12. As shown in FIGS. 2a and 2b, the first force sensor 18a measures the right radial bearing force Fᵣ₁, and the left force sensor 18b measures the left radial bearing force Fᵣ₂. The radial bearing forces Fᵣ₁ and Fᵣ₂ are equal when the running direction of the substrate web 6 is straight and centered (see FIG. 2a). However, as soon as the substrate web 6 becomes skewed and/or displays an offset z (FIG. 2b), the substrate web 6 is unevenly tensioned, and the radial bearing forces Fᵣ₁ and Fᵣ₂ deviate from each other. Thus, the evaluation circuit determines a difference between the radial bearing forces Fᵣ₁ and Fᵣ₂, said difference representing a deviation from the ideal, straight running direction of the substrate web 6. A positive difference, for example, represents a deviation of the running direction toward the right, and a negative difference represents the deviation of the running direction toward the left.

In this exemplary embodiment, a calibrating method may be used to determine the position of the substrate web 6 relative to the measuring roller 12. With such a method for measuring the position of the substrate web 6 relative to the measuring roller 12, the substrate web 6 is first moved around the measuring roller 12 in a first defined position and tensioned with the tensioning force F_{S}. First radial bearing forces Fᵣ₁, Fᵣ₂ are measured in this position. In this first position, for example, the right edge of the substrate web 6 abuts against the right edge of the measuring roller 12. Then, the substrate web 6 is guided around the measuring roller 12 in a second defined position, and the tensioning force F_{S} is applied to said substrate web. In this second defined position, two radial bearing forces Fᵣ₁ and Fᵣ₂ are measured in order to determine a second difference between the two radial forces. In the second defined position, for example, the left edge of the substrate web 6 abuts against the left edge of the measuring roller 12.

Now that a first difference of the radial forces in a first defined position or a first offset z is known and also a second difference of the radial bearing forces in a second defined position or a second offset z is known, the relationship between the offset z and the difference of the radial bearing forces can be determined, as is shown in FIG. 4. The force sensors 18a and 18b continuously measure the radial bearing forces Fᵣ₁ and Fᵣ₂ and transmit their values to the electronic evaluation system. The electronic evaluation system then determines—by interpolation between the known pairs of values—an offset z corresponding to any just measured difference between the two most recent radial bearing forces Fᵣ₁ and Fᵣ₂.

In accordance with yet another exemplary embodiment, the edge sensor 22 measures the position of the edge of the substrate web 6. In the shown exemplary embodiment, the edge sensor 22 is an optical sensor, for example, a laser sensor or a light barrier. The data output by the edge sensor 22 may also be transmitted to the electronic evaluation system. The signal of the edge sensor 22 may be filtered through a low-pass filter to prevent any irregularities along the edge of the substrate web 6 from entering in the measurement. The edge sensor 22 may comprise a sensor arrangement which enables the direct detection of the position of the edge of the substrate web 6 as an absolute value. Alternatively, the edge sensor 22 can provide only a single measuring point, for example, when the edge sensor 22 is a laser light barrier. In this case, the output value of the edge sensor 22 only indicates whether or not the edge has exceeded the measuring point of the edge sensor 22. Such an edge sensor is disposed to determine the position of the substrate web 6 and can be used in addition to the force sensors 18a, b, c. It is also conceivable that an edge sensor 22 be used in conjunction with a force sensor 18c in order to determine the alignment and the position of the substrate web 6.

As soon as the evaluation circuit has determined the position and/or the alignment of the substrate web 6, these can be corrected by the adjustment device 11 should any deviations exist. The device 11 changes the position and/or the alignment of at least one adjustment roller 24 in a controllable manner. The position and the alignment of the substrate web 6 change as a function of the adjustment roller 24. If, as shown in FIG. 3, a measuring roller 12 each is arranged—viewed in running direction of the substrate web 6—upstream and downstream of the adjustment rollers 24, it is possible to check the success of the adjustment operation.

The invention has been described with reference to preferred exemplary embodiments, whereby the individual features of the described exemplary embodiments may be freely combined with each other and/or interchanged, provided they are compatible. Numerous modifications and configurations are obvious to the person skilled in the art, without departure from the inventive idea.

1. Method for measuring a running direction of a substrate web, wherein the substrate web is guided around a measuring roller, said method comprising the following steps:
measuring at least one bearing force of the measuring roller; and
determining the running direction of the substrate web based on the measured bearing force.

2. Method as in claim 1, wherein the step of measuring the bearing force comprises measuring an axial bearing force of the measuring roller.

3. Method as in claim 1, wherein the step of measuring the bearing force comprises measuring radial bearing forces at two points, axially spaced apart, of the measuring roller.

4. Method as in claim 3, wherein the step of measuring the radial forces comprises measuring the radial bearing forces at opposite ends of the measuring roller.

5. Method as in claim 3, wherein the step of determining the running direction of the substrate web comprises determining a difference between the radial bearing forces.

6. Method as in claim 1, said method further comprising the step of measuring a position of the edge of the substrate web.

7. Method as in claim 6, wherein the position of the edge of the substrate web is measured by optical means.

8. Method as in claim 6, wherein the measured position of the edge of the substrate web is processed through a low-pass filter.

9. Method for aligning the running direction of a substrate web, wherein the running direction is defined as in claim 1; and wherein the running direction is adjusted by means of at least one adjustment element.

10. Method for aligning the running direction of a substrate web as in claim 9, wherein the running direction is adjusted by way of at least one controllable adjustment roller.

11. Method for aligning the running direction of a substrate web as in claim 9, wherein the running direction is determined in transport direction upstream of the adjustment element.

12. Method for aligning the running direction of a substrate web as in claim 9, wherein the running direction is determined in transport direction upstream and downstream of the adjustment element.

13. Method for preparing a graph for the determination of the position of a substrate web relative to a measuring roller, said method comprising the following steps:
guiding the substrate web around the measuring roller;
measuring first radial bearing forces at two points, axially spaced apart, of the measuring roller, in which case the substrate web is arranged in a first defined position on the measuring roller;
determining a first difference between the two radial bearing forces;
measuring second radial bearing forces at two points, axially spaced apart, on the measuring roller, in which case the substrate web is arranged in a second defined position of the measuring roller;
determining a second difference between the two radial bearing forces; and
determining a relationship between a position of the substrate web on the measuring roller and a difference of radial bearing forces based on the first and second differences and the corresponding first and second defined positions.

14. Device for measuring the running direction of a substrate web by way of a measuring roller, around which the substrate web can be guided, said device comprising the following:
at least one sensor for measuring a bearing force of the measuring roller;
an evaluation circuit, said evaluation circuit being connected to the at least one sensor and being suitable for determining an alignment of the substrate web based on the bearing force measured by the sensor.

15. Device as in claim 14, the at least one sensor being suitable for measuring an axial bearing force.

16. Device as in claim 15, with two sensors being suitable for measuring a radial bearing force.

17. Device as in claim 16, said sensors for measuring the radial bearing force being aligned in such a manner that they perform measurements in the direction of the bisector of the wrap angle of the substrate web around the measuring roller.

18. Device for adjusting the running direction of a substrate web transversely to a transport direction of said web, said device comprising the following:
a device for measuring the running direction as in claim 14; and
at least one adjustment element for adjusting the running direction of the substrate web.

19. Device for adjusting the running direction of a substrate web as in claim 18, said device for measuring the running direction being arranged upstream of the adjustment element.

20. Device for adjusting the running direction of a substrate web as in claim 18, said device comprising a second device for measuring the running direction of a substrate web; with one device, respectively, for measuring the running direction of a substrate web being arranged in transport direction of the substrate web upstream and downstream of the at least one adjustment element.

21. Device for adjusting the running direction of a substrate web as in claim 18, said adjustment element comprising at least one controllably movable adjustment roller.

22. Device for adjusting the running direction of a substrate web as in claim 18, said device comprising an edge sensor for measuring the position of the edge of the substrate web.

23. Printing machine comprising at least one printing unit and one device for measuring the running direction of a substrate web.

24. Printing machine as in claim 23, said device for measuring the running direction being arranged in transport direction of the substrate web upstream of the at least one printing unit.

25. Printing machine as in claim 23, said device for measuring the running direction of a substrate web web being provided at an adjustment element for adjusting the running direction of the substrate web.

26. Printing machine as in claim 25, said adjustment element being part of a roller frame of the printing machine.
